(19) United States
(12) Patent Application Publication
(10) Pub. No.: US 2017/0256058 A1
(43) Pub. Date: Sep. 7, 2017

(54) APPARATUS AND METHOD FOR DETECTING CIRCLE

(71) Applicant: Electronics and Telecommunications Research Institute, Daejeon-si (KR)

(72) Inventors: Sang Woo SEO, Daejeon-si (KR); Myung Gyu KIM, Daejeon-si (KR); Woo Suk KIM, Daejeon-si (KR); Jong Sung KIM, Daejeon-si (KR); Il Kwon JEONG, Daejeon-si (KR)

(73) Assignee: Electronics and Telecommunications Research Institute, Daejeon-si (KR)

(21) Appl. No.: 15/251,174

(22) Filed: Aug. 30, 2016

(30) Foreign Application Priority Data
Mar. 4, 2016 (KR) 10-2016-0026433

(51) Int. Cl. G06T 7/00; G06T 7/60; G06T 7/40

(52) U.S. Cl. CPC G06T 7/0085; G06T 7/0083; G06T 7/0095; G06T 7/403; G06T 7/408; G06T 7/602; G06T 7/606; G06T 2207/10024; G06T 2207/20061; G06T 2207/20144

(57) ABSTRACT

An apparatus and method for detecting a circle are provided. The apparatus includes an edge detector configured to generate a foreground image from a background image generated from an input image and generate edge pixel information from the foreground image, and a voting processor configured to calculate a position of a central point and a radius of a circle by performing a circle Hough transform using the edge pixel information.

### CROSS-REFERENCE TO RELATED APPLICATION(S)

This application claims priority from Korean Patent Application No. 10-2016-0026433, filed on Mar. 4, 2016, in the Korean Intellectual Property Office, the disclosure of which is incorporated herein by reference in its entirety.

### BACKGROUND

1. Field

The following description relates to pattern recognition technology, and more particularly, to an apparatus and method for detecting a circle which are frequently used in various computer vision fields such as virtual sports, facial recognition, and so on.

2. Description of Related Art

Circle detection technology is necessary for a preprocessing operation in various computer vision fields, such as virtual sports simulation, pupil recognition, etc., and much research is underway to develop a high speed hardware engine for real-time processing of the circle detection technology.

In particular, a virtual sports simulation in which a high-speed camera is used requires circle detection technology having a high speed of several milliseconds or less, but most existing techniques do not satisfy requirements for such processing performance.

Generally, a circle detector using a Hough transform performs an edge detection operation and a voting operation based on the Hough transform.

The edge detection operation includes a total of four operations (filtering, gradation, non-maximum suppression, and hysteresis thresholding). The gradation operation requires calculation of H(x, y)=Σᵢ₌₀^{M}^{ᵢ}⁻¹Σⱼ₌₀^{M}^{ⱼ}⁻¹I(x+i−aᵢ, y+j−aⱼ)G(i,j) and uses

$$λ = atan ( \frac{{G}_{y}}{{G}_{x}} )$$

to calculate an angle. Here, calculation of a trigonometric function and a division operation implemented by hardware do not only degrade performance but also require a large area, and thus are not appropriate for hardware implementation.

The voting operation has been extensively researched to reduce time complexity or hardware costs. From the research, according to an incremental circle Hough transform (ICHT) which has been developed recently, a circle is calculated in the form of a Taylor series to avoid using a trigonometric function like in a coordinate rotation digital computer (CORDIC) algorithm, but there is a considerably large error when dθ is small. Also, since a current value is calculated using a previous value, there is a continuous dependency on previous data, and parallel processing is not possible through hardware implementation. Further, when a circle is expressed, many points of the circle may be shown as one pixel, and in this case, a central point of the circle may be incorrectly selected.

### SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

The following description relates to a hardware-based apparatus and method for detecting a circle using a Hough transform which reduce costs and time complexity for calculation and thus can be implemented by hardware.

The following description also relates to a hardware-based apparatus and method for detecting a circle in which parallel calculation is used for real-time processing.

In one general aspect, an apparatus for detecting a circle includes: an edge detector configured to generate a foreground image from a background image generated from an input image and generate edge pixel information from the foreground image; and a voting processor configured to calculate a position of a central point and a radius of a circle by performing a circle Hough transform using the edge pixel information.

In another general aspect, a method of detecting a circle includes: generating a foreground image from a background image generated from an input image and generating edge pixel information from the foreground image; and calculating a position of a central point and a radius of a circle by performing a circle Hough transform using the edge pixel information.

Other features and aspects will be apparent from the following detailed description, the drawings, and the claims.

### BRIEF DESCRIPTION OF THE DRAWINGS

FIG. 1 is a block diagram of an apparatus for detecting a circle according to an exemplary embodiment of the present invention.

FIG. 2 shows a detailed configuration of an edge detector according to an exemplary embodiment of the present invention.

FIG. 3 is a diagram illustrating generation of a background image.

FIG. 4 shows a detailed configuration of a voting processor according to an exemplary embodiment of the present invention.

FIGS. 5 and 6 are diagrams illustrating voting processing according to the present invention.

FIG. 7 is a flowchart illustrating a method of detecting a circle according to an exemplary embodiment of the present invention.

FIG. 8 is a flowchart illustrating an edge detection operation according to an exemplary embodiment of the present invention.

FIG. 9 is a flowchart illustrating a voting processing operation according to an exemplary embodiment of the present invention.

Throughout the drawings and the detailed description, unless otherwise described, the same drawing reference numerals should be understood as referring to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will be proposed to those of ordinary skill in the art. Also, descriptions of well-known functions and constructions may be omitted for increased clarity and conciseness. Throughout the drawings, like reference numbers refer to like elements.

The terms used in the following description are terms defined in consideration of functions in exemplary embodiments of the present invention and may vary depending on an intention of a user or an operator, a practice, and so on. Therefore, definitions of terms used herein should be made based on the content throughout the specification.

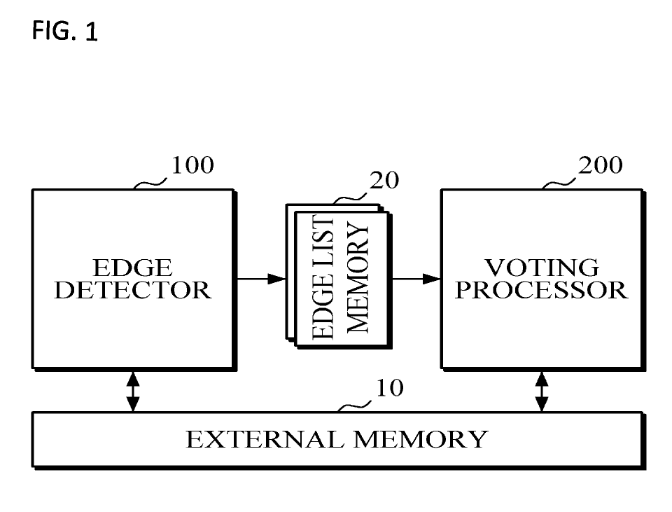

FIG. 1 is a block diagram of an apparatus for detecting a circle according to an exemplary embodiment of the present invention.

Referring to FIG. 1, an apparatus for detecting a circle includes an edge detector 100 and a voting processor 200. Additionally, the apparatus includes an external memory 10 and an edge list memory 20.

Here, the external memory 20 is a general dynamic random access memory (DRAM) (a display data RAM (DDRAM), a double data rate type 2 (DDR2) DRAM, a double data rate type 3 (DDR3) DRAM, etc.) which is slower than an internal memory (a static RAM (SRAM)) but has a large capacity. Therefore, a high-capacity camera image is stored in the external memory and then input to the edge detector 100, and a final result of a Hough transform performed by the voting processor 200 becomes an output of the external memory 10.

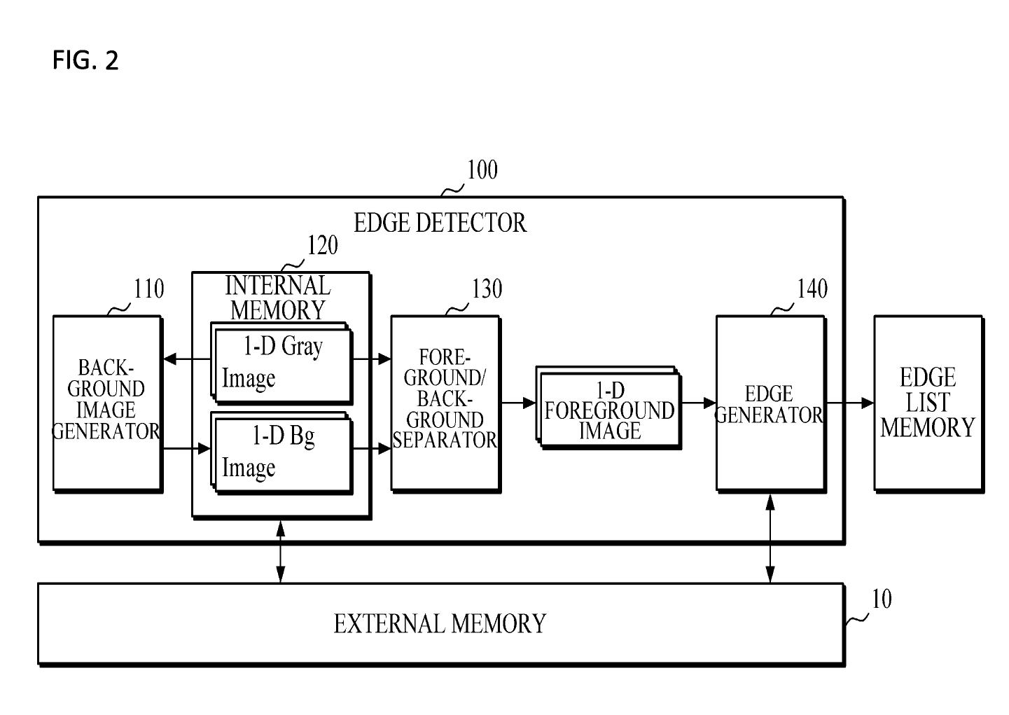

The edge detector 100 generates a foreground image from a background image generated from the input image and generates edge pixel information from the foreground image. The edge detector 100 will be described in detail below with reference to FIG. 2.

Because there are not many edge pixels, the edge pixel information generated by the edge detector 100 is stored in the edge list memory 20 which is in the form of an internal memory.

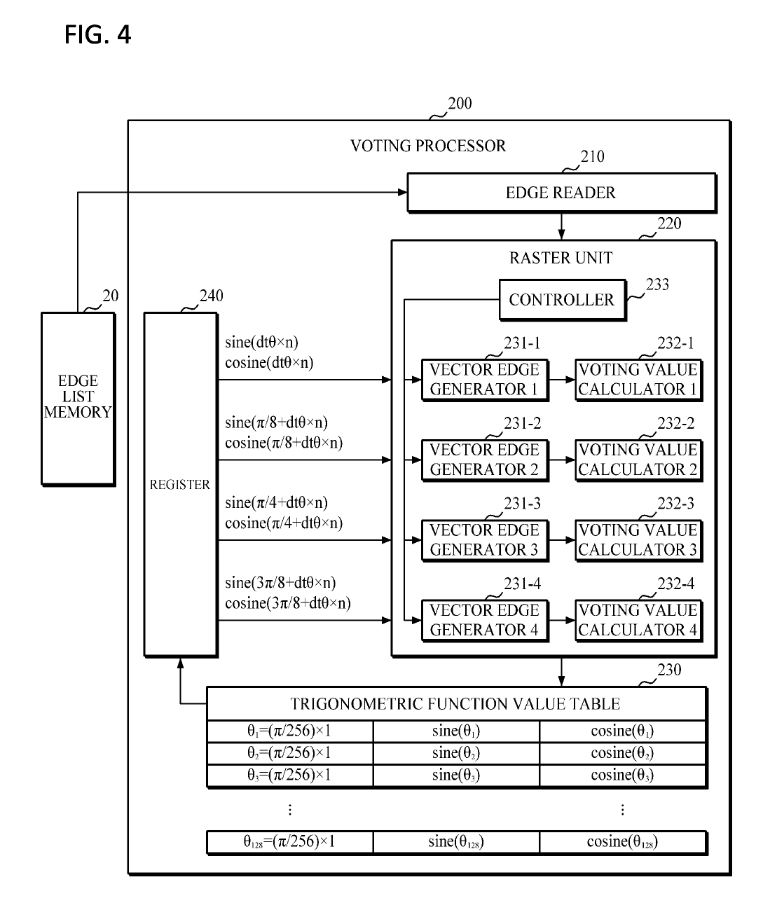

The voting processor 200 performs a circle Hough transform using the edge pixel information generated by the edge detector 100, thereby calculating a position of a central point and a radius of a circle. The edge detector 100 will be described in detail below with reference to FIG. 4.

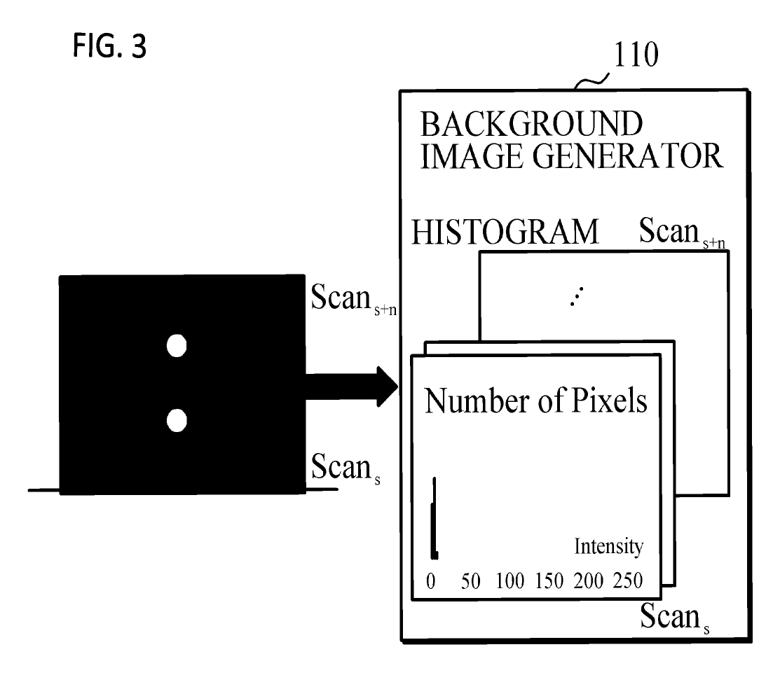

FIG. 2 shows a detailed configuration of an edge detector according to an exemplary embodiment of the present invention, and FIG. 3 is a diagram illustrating generation of a background image.

Referring to FIG. 2, the edge detector 100 includes a background image generator 110, an internal memory 120, a foreground/background separator 130, and an edge generator 140.

The background image generator 110 generates a background image from an input image and stores the background image in the internal memory 120. Referring to FIG. 3, all histograms for respective scan lines are generated, and a color having a predetermined value or more in a cumulative probability distribution of the generated histograms is determined as a background color. For example, a color having a value of half (0.5) of the cumulative probability distribution is determined as the background color. Here, an input parameter for the cumulative probability distribution may change according to surroundings.

From the generated background image, the foreground/background separator 130 acquires a foreground mask image, that is, it generates a foreground image of the input image having a different value, which is a predetermined threshold or more, from the background image. In other words, [Equation 1] below is used to extract the foreground image.

$${F}_{i , j} = \{ \begin{matrix}1 , & \vert {I}_{i , j} - {B}_{i , j} \vert \geq {T}_{d} \\ 0 , & otherwise\end{matrix} \qquad [ Equation 1 ]$$

In [Equation 1], F_{i,j} is an output foreground image, I_{i,j} is an input image, B_{i,j} is a background image, and T_{d} is a set threshold. Ranges of i and j become a width and a height of a two-dimensional (2D) image. For example, when the input image has a video graphics array (VGA) resolution of 640×480, its width is 640 and its height is 480. Also, i and j may be any of the width and the height, and the ranges are not limited. T_{d} may change according to a color range of the input image. For example, in an image of 8-bit colors having values of 0 to 255, T_{d} may be 0 to 255. In other words, the value of T_{d} may be defined within a color range of an input image. Also, T_{d} is a threshold, and a parameter determined according to a user or an environment. T_{d} may not be determined as an extreme value, such as 0 or 255, but may be determined within a range of 50 to 100.

The edge generator 140 obtains edge pixels from the foreground image and stores the position values in the edge list memory 20. Here, the edge pixels are calculated from the foreground image by [Equation 2] below.

$${E}_{i , j} = \{ \begin{matrix}1 , & {F}_{i , j} \neq {F}_{i , j - 1} \\ 1 , & {F}_{i , j} \neq {F}_{i - 1 , j} \\ 1 , & {F}_{i , j} \neq {F}_{i - 1 , j - 1} \\ 0 , & otherwise\end{matrix} \qquad [ Equation 2 ]$$

FIG. 4 shows a detailed configuration of a voting processor according to an exemplary embodiment of the present invention.

Referring to FIG. 4, the voting processor 200 includes an edge reader 210 and a raster unit 220. Additionally, the voting processor 200 includes a trigonometric function value table 230 and a register 240.

The edge reader 210 reads information on the edge pixels from the edge list memory 20.

The raster unit 220 performs a circle Hough transform using the edge pixel information output by the edge reader 210, thereby calculating a position of a central point and a radius of a circle. Specifically, the raster unit 220 includes a plurality of vectored edge generators (VEGs) 231-1 to 231-4, a plurality of voting value calculators 232-1 to 232-4, and a controller 233. FIG. 4 shows a configuration including four VEGs, but the configuration is just an exemplary embodiment for convenience of description and the present invention is not limited thereto.

The controller 233 sets a radius of a circle which will be subjected to voting processing. Here, a range of a radius r of the circle may be appropriately selected by the user or may be effectively applied using a labeling technique which is widely used in pattern recognition. According to the labeling technique, a range of a region determined to be each object is set and labelled, and a portion which is not determined to be an object is removed. A range of the radius may be defined by a minimum radius and a maximum radius.

Each of the four VEGs 231-1 to 231-4 simultaneously generates vectored edges (VEs) centered on an edge pixel position. Each of the VEGs 231-1 to 231-4 performs a calculation corresponding to an angle of π/8 (0° to 22.5°, 22.5° to 45°, 45° to 67.5°, and 67.5° to 90°). When the circle has a small radius, dtθ may be set to reduce calculation costs as shown in [Equation 3] below.

$$dt θ = \{ \begin{matrix}k = \frac{128}{{2}^{⌊ \frac{r + 1}{2} ⌋}} , & ( k \geq 1 ) \\ 1 , & ( k < 1 )\end{matrix} \qquad [ Equation 3 ]$$

According to an exemplary embodiment, there are the four VEGs, and thus n may be

$$\frac{128}{4 \times dt θ}$$

in [Equation 3]. According to an exemplary embodiment, the raster unit 220 may acquire a trigonometric function value previously stored in the trigonometric function value table 230 through the register 240 and use the trigonometric function value in a calculation.

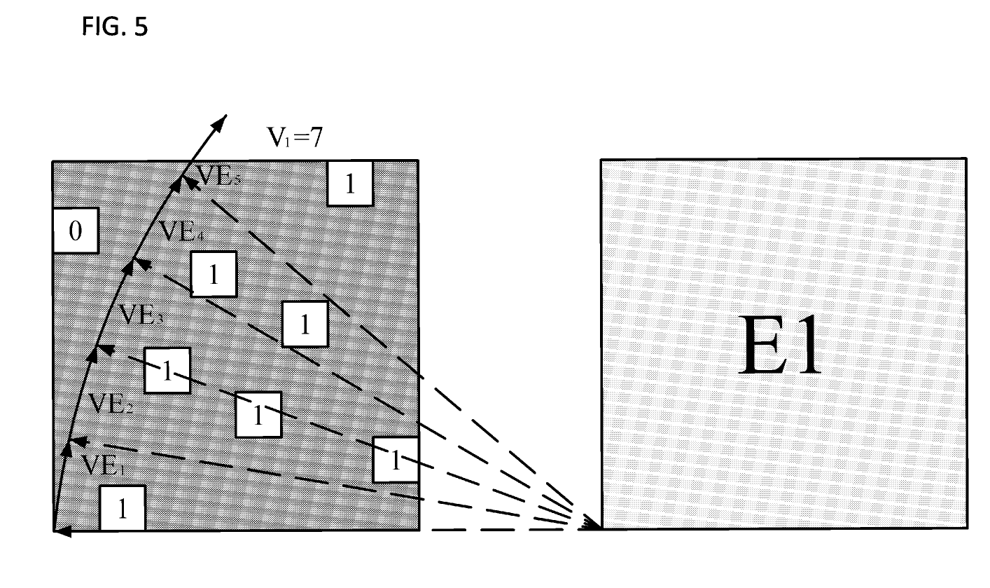

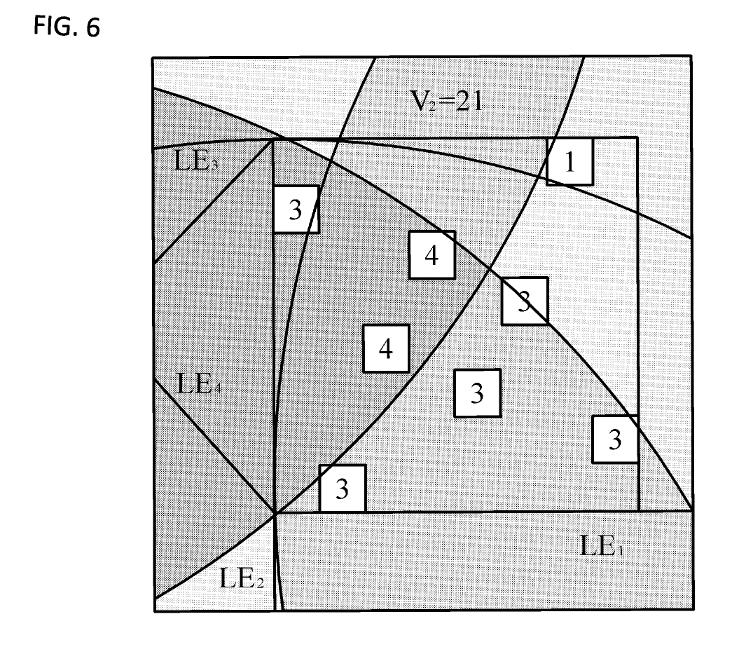

The voting value calculators 232-1 to 232-4 calculate voting values for each of the VEs generated by the VEGs 231-1 to 231-4. When many VEs extend over one pixel, an incorrect position may be selected as the center of the circle, and thus 8×8 super-sampling is used according to an exemplary embodiment. A super-sampling pattern may vary. This will be described with reference to FIGS. 5 and 6.

Referring to FIG. 5, whether or not a sub-pixel in a single pixel on a left side is included in a generated VE and a cumulative value Flag of pixels is in accordance with the equation of a straight line in [Equation 4] below.

Side=(V_{0y}−V_{1y})×(SPₓ−V₀ₓ)+(V₁ₓ−V₀ₓ)×(SP_{y}−V_{0y})

Flag=Flag+1, if side<0 [Equation 4]

Referring to FIG. 6, LEₙ denotes a line generated from each edge pixel Eₙ. When sub-pixels are defined as sp0, sp1, sp2, . . . , and sp7 from the bottom to top, VEs generated from LE₁ extend over sp0, sp1, sp2, sp3, sp4, sp5, and sp7, VEs generated from LE₂ extend over sp0, sp1, sp2, sp3, sp4, sp5, and sp6, VEs generated from LE₃ extend over sp0, sp1, sp2, sp3, sp4, sp5, and sp6, and VEs generated from LE₄ extend over sp4, sp5, and sp6. Therefore, a final voting (V2) value is 24. Since the final voting value is larger than 7 which is a V1 value of FIG. 5, V2 may be finally selected as the center of the circle.

When the voting value calculators 232-1 to 232-4 calculate all voting values for a single edge, the VEGs 231-1 to 231-4 generate new VEs, and the voting value calculators 232-1 to 232-4 calculate voting values for the new VEs. The VEGs 231-1 to 231-4 and the voting value calculators 232-1 to 232-4 repeat such operations until all VEs for the radius are processed.

When all VEs for the set radius are processed by the VEGs 231-1 to 231-4 and the voting value calculators 232-1 to 232-4, the controller 233 sets a new radius by adding 1 to the current radius and controls the VEGs 231-1 to 231-4 and the voting value calculators 232-1 to 232-4 to calculate voting values for the new radius.

The voting processor 200 performs the above described operations for all edge pixels of the image.

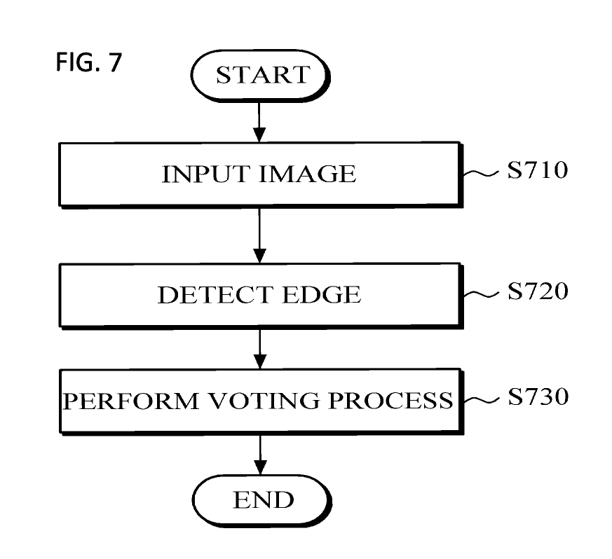

FIG. 7 is a flowchart illustrating a method of detecting a circle according to an exemplary embodiment of the present invention.

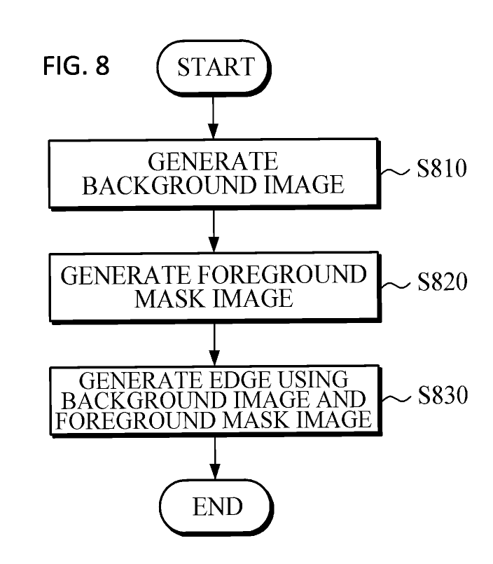

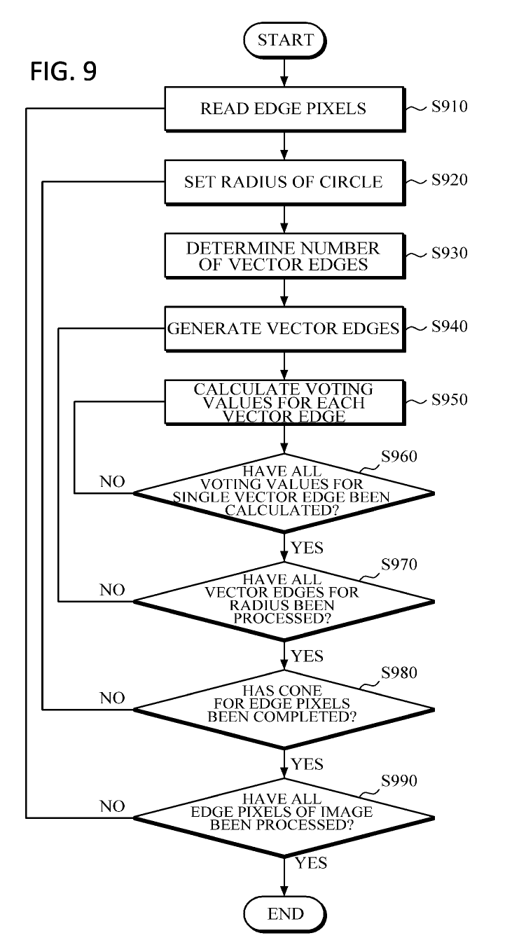

Referring to FIG. 7, when an image is input (S710), an apparatus for detecting a circle generates a foreground image from a background image generated from the input image and generates edge pixel information from the foreground image (S720, see FIG. 8). Then, the apparatus for detecting a circle performs a circle Hough transform using the edge pixel information to calculate a position of a central point and a radius of a circle (S730, see FIG. 9).

FIG. 8 is a flowchart illustrating an edge detection operation according to an exemplary embodiment of the present invention.

Referring to FIG. 8, an apparatus for detecting a circle generates a background image from an input image (S810). Referring to FIG. 3, the apparatus for detecting a circle generates all histograms of respective scan lines and determines a color which has a predetermined value or more in a cumulative probability distribution of the generated histograms as a background color. For example, a color having a value of half (0.5) of the cumulative probability distribution is determined as the background color. Here, an input parameter for the cumulative probability distribution may change according to surroundings.

From the generated background image, the apparatus for detecting a circle acquires a foreground mask image (S820), that is, it generates a foreground image of the input image having a different value, which is a predetermined threshold or more, from the background image. In other words, [Equation 1] above is used to extract the foreground image.

The apparatus for detecting a circle generates edge pixels from the foreground image (S830). Here, the edge pixels are calculated from the foreground image by [Equation 2] above.

FIG. 9 is a flowchart illustrating a voting processing operation according to an exemplary embodiment of the present invention.

Referring to FIG. 9, an apparatus for detecting a circle reads information on edge pixels (S910), and then sets a radius of a circle (S920). Here, a range of the radius of the circle may be selected by a user or selected using a labeling technique which is widely used in pattern recognition. According to the labeling technique, a range of a region determined to be each object is set and labelled, and a portion which is not determined to be an object is removed. A range of the radius may be defined by a minimum radius and a maximum radius.

Subsequently, the apparatus for detecting a circle determines the number of VEs (S930), and generates VEs centered on an edge pixel position (S940). According to an exemplary embodiment, when the number of VEs is determined to be 4, the apparatus for detecting a circle simultaneously generates four VEs centered on the edge pixel position. In other words, the apparatus for detecting a circle simultaneously performs calculations corresponding to an angle of π/8 (0° to 22.5°, 22.5° to 45°, 45° to 67.5°, and 67.5° to 90°) in parallel. When the circle has a small radius, dtθ may be set to reduce calculation costs as shown in [Equation 3] above.

The apparatus for detecting a circle calculates voting values for each of the generated VEs (S950). When many VEs extend over one pixel, an incorrect position may be selected as the center of the circle, and thus 8×8 super-sampling is used according to an exemplary embodiment. A super-sampling pattern may vary.

The apparatus for detecting a circle determines whether calculations of all voting values for a single VE have been finished (S960).

When it is determined in S960 that calculations of all voting values for the single VE have not been finished, the apparatus for detecting a circle performs S950 again. On the other hand, when it is determined in S960 that the calculations of all voting values for the single VE have been finished, the apparatus for detecting a circle determines whether all VEs for the set radius have been processed (S970).

When it is determined in S970 that all of the VEs for the set radius have not been processed, the process goes back to S940, and the apparatus for detecting a circle generates a new VE (S940), and calculates voting values for the new VE (S950). S940 and S950 are repeated until all of the VEs for the set radius are processed. On the other hand, when it is determined in S970 that all of the VEs for the set radius have been processed, the apparatus for detecting a circle determines whether a cone for the edge pixels has been completed (S980).

When it is determined in S980 that the cone for the edge pixels has not been completed, the process goes back to S920, and the apparatus for detecting a circle sets a new radius by adding 1 to the previously set radius (S920). Subsequently, the apparatus for detecting a circle performs S930 to S970 to calculate voting values for the new radius. On the other hand, when it is determined in S980 that the cone for the edge pixels has been completed, the apparatus for detecting a circle determines whether all of the edge pixels of the input image have been processed (S990).

When it is determined in operation S990 that all of the edge pixels of the input image have not been processed, the process goes back to S910, and the apparatus for detecting a circle performs S910 to S980 again.

According to the present invention, it is possible to calculate a radius and a position of a circle from a grayscale image.

According to the present invention, separate histograms are generated in units of scan lines to obtain a background image from a cumulative probability distribution and separate a foreground image and the background image from each other, so that an edge may be detected through only addition/subtraction operations without complex calculation. Also, since calculation is performed in units of scan lines, parallel calculation is possible.

During voting processing of the present invention, a trigonometric function value which is previously calculated in a preprocessing operation is used so that no trigonometric function calculator is used. Also, a circle Hough transform with high accuracy is enabled through vectorization and super-sampling.

Further, since all calculations are separately performed, parallel calculation is possible which helps improve system performance.

A number of examples have been described above. Nevertheless, it should be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. An apparatus for detecting a circle, the apparatus comprising:
an edge detector configured to generate a foreground image from a background image generated from an input image and generate edge pixel information from the foreground image; and
a voting processor configured to calculate a position of a central point and a radius of a circle by performing a circle Hough transform using the edge pixel information.

2. The apparatus of claim 1, wherein the edge detector generates all histograms of respective scan lines and determines a color having a predetermined value or more in a cumulative probability distribution of the histograms as a background color.

3. The apparatus of claim 1, wherein the edge detector generates the foreground image of the input image having a different value, which is a predetermined threshold or more, from the background image.

4. The apparatus of claim 1, wherein the voting processor includes a trigonometric function value table storing a predetermined number of trigonometric function values at predetermined angular intervals, and calculates the position of the central point and the radius of the circle using the trigonometric function values stored in the trigonometric function value table.

5. The apparatus of claim 4, wherein the predetermined number of trigonometric function values is a square of two.

6. The apparatus of claim 1, wherein, after reading the edge pixel information, the voting processor sets the radius of the circle, determines a number of vectored edges (VEs), generates the determined number of VEs centered on a position of an edge pixel, and calculates voting values for each of the generated VEs.

7. The apparatus of claim 6, wherein a range of the radius of the circle is selected by a user or selected using a labeling technique widely used in pattern recognition.

8. The apparatus of claim 6, wherein the voting processor repeatedly calculates voting values for each of the generated VEs until all of the VEs for the set radius are processed.

9. The method of claim 6, wherein, when all of the VEs for the set radius are processed, the voting processor calculates voting values for a new radius.

10. The method of claim 6, wherein the voting processor repeatedly sets the radius of the circle, determines a number of VEs, generates the determined number of VEs centered on a position of an edge pixel, and calculates voting values for each of the generated VEs until all edge pixels of the input image are processed.

11. A method of detecting a circle, the method comprising:
generating a foreground image from a background image generated from an input image and generating edge pixel information from the foreground image; and
calculating a position of a central point and a radius of a circle by performing a circle Hough transform using the edge pixel information.

12. The method of claim 11, wherein the generating of the foreground image includes generating all histograms of respective scan lines and determining a color having a predetermined value or more in a cumulative probability distribution of the histograms as a background image.

13. The method of claim 11, wherein the generating of the foreground image includes generating the foreground image of the input image having a different value, which is a predetermined threshold or more, from the background image.

14. The method of claim 11, wherein the calculating of a position of a central point and a radius includes:
reading the edge pixel information;
setting the radius of the circle;
determining a number of vectored edges (VEs), generating the determined number of VEs centered on a position of an edge pixel; and
calculating voting values for each of the generated VEs.

15. The method of claim 14, wherein a range of the radius of the circle is selected by a user or selected using a labeling technique widely used in pattern recognition.

16. The method of claim 14, wherein the calculating of a position of a central point and a radius further includes repeating operations from the determining of a number of VEs to the calculating of voting values for each of the generated VEs until all of the VEs for the set radius are processed.

17. The method of claim 16, wherein the calculating of a position of a central point and a radius further includes setting a new radius when all of the VEs for the set radius are processed, and repeating operations from the determining of a number of VEs to the calculating of voting values for each of the generated VEs until all the VEs for the new radius are processed.

18. The method of claim 17, wherein the calculating of a position of a central point and a radius further includes repeating operations from the setting of a radius of a circle to the calculating of voting values for each of the generated VEs until all edge pixels of the input image are processed.
